(19) United States
(12) Patent Application Publication
(10) Pub. No.: US 2011/0001952 A1
(43) Pub. Date: Jan. 6, 2011

(54) Resist exposure and contamination testing apparatus for EUV lithography

(75) Inventors: James H. Underwood, Oakland, CA (US); Rupert C. Perera, Martinez, CA (US)

Correspondence Address: THEODORE J. BIELEN JR.;BIELEN, LAMPE, & THOEMING, 1390 WILLOW PASS ROAD, SUITE 1020, CONCORD, CA, 94520, US

(73) Assignee: Eran & Jan, Inc

(21) Appl. No.: 12/586,672

(22) Filed: Sep. 24, 2009

Related U.S. Application Data
(60) Provisional application No. 61/194,342, filed on Sep. 25, 2008.

(51) Int. Cl. G03B 27/72

(52) U.S. Cl. 355/71

(57) ABSTRACT

An resist exposure and contamination testing apparatus for extreme ultraviolet lithography utilizing a wafer coated with a resist. A source of electromagnetic radiation produces a first electromagnetic beam. A deflection mirror receives the first electromagnetic beam and removes debris therefrom. The deflection mirror also produces a second electromagnetic beam free of such debris. A filter receives the second electromagnetic beam and removes visible light and near ultraviolet radiation therefrom while passing a third electromagnetic beam. A focusing element receives the third electromagnetic beam and produces a fourth electromagnetic beam of extreme ultraviolet radiation in the form of a spot onto the wafer coated with a resist.

### CROSS-REFERENCES TO RELATED APPLICATIONS

The present application claims the benefit of U.S. Provisional Patent Application Ser. No. 61/194,342 filed 25 Sep. 2008.

### BACKGROUND OF THE INVENTION

The present invention relates to a novel and useful resist exposure and contamination testing apparatus applicable to extreme ultraviolet lithography techniques.

Extreme ultraviolet (EUV) lithography is a technology developed for the manufacture of intergrated circuits, also known as ICs or chips. EUV lithography is currently viewed as the most promising approach for reaching the 22 nanometer node in the manufacture of such in silicon devices. In this technology, very short wavelength ultraviolet light with a wavelength of about 13.4-13.5 nanometers is used instead of visible or near ultraviolet light as the source for the lithographic printing process. The EUV short wavelength allows much finer features to be recorded or printed on a silicon wafer than these produced with existing technologies. Needless to say, recording finer features on silicon wafers will allow a much higher microcircuit density on the chip.

EUV lithography (EUVL) requires very sophisticated reflecting optics or mirrors. The entire optical train of EUV lithography, including the source, lithographic mask, optics, and the silicon wafer bearing the recording medium, must operate in a high vacuum. This complete tool for loading and exposing the wafers is called a “stepper” or a “stepper tool”. EUV steppers are currently being used and developed around the world.

Critical to EUV lithography is the development of a suitable EUV-sensitive resist. A resist, or photoresist, is a thin film of, typically, organic material coated on the silicon wafer by a spinning process. Resists presently used for lithography employing radiation in the visible and near ultraviolet regions are not suitable for the EUV spectral region. A suitable resist for EUV lithography must have several important properties. They are:

1. A EUV resist must be sufficiently sensitive to the 13.4 nm UV light.

2. A UV resist must be capable of being spun onto the silicon wafer.

3. During an exposure, an EUV resist must not evolve organic materials that could contaminate other components of the stepper, in particular the optics. Ideally, the “outgassing” of the EUV resist during exposure should be negligible. Contamination of the mirror portion of the stepper would reduce reflectivity of EUV light and degrade the performance of the system considerably, both in terms of image quality and wafer production capacity.

In the past, a source of EUV radiation has been employed and passed, without further manipulation through a visible light filter to a wafer. The filter also served as vacuum barrier between the working gas of the source (e.g. xenon) and the high vacuum experimental chamber to prevent absorption of EUV by such working gas. Unfortunately, long exposures are required on a wafer using this method, since there is no control on the size of the spot on the wafer. Also, prior art vanes and a buffer gas have been used to block debris and ions in the EUV radiation beam to protect the filter but, again, the pattern of radiation arriving at the wafer is inconsistent and produces non-uniform exposure results.

An apparatus that allows the determination of sensitivity of resists under known quantities of EUV light, in addition to measuring of outgassing during exposure, would be a notable advance in the electronic manufacturing field.

### BRIEF SUMMARY OF THE INVENTION

In accordance with the present invention a novel and useful resist exposure and contamination testing apparatus for use with extreme ultraviolet lithography is herein provided.

The apparatus of the present invention utilizes a wafer, such as a silicon wafer, coated with a candidate resist. The wafer may be located on a support or stage which is movable in the x-y directions. The source of electromagnetic radiation normally includes visible light and undesirable particulate debris and ions.

The source of electromagnetic radiation produces a first electromagnetic beam that passes to a deflection mirror. The deflection mirror is capable of blocking unwanted particulate matter and undesirable ions, such as xenon ions. At the same time the deflection mirror reflects a high percentage of ultraviolet light and a very high percentage of extreme ultraviolet radiation, about 90 percent. For example, the deflection mirror may be optically polished glass coated with ruthenium metal and is positioned at a grazing angle of about 12.5 degrees to the incoming first electromagnetic beam. In a sense, the deflection mirror is a “sacrificial” mirror since it is intended to be replaced though normal maintenance, although, it is not subject to rapid damage. The electromagnetic beam reflected from deflection mirror may be considered to be a second electromagnetic beam.

A filter receives the second electromagnetic radiation beam from the deflection mirror and removes visible light and UV therefrom. The filter also forms a gas excluding barrier to the following optical elements of the system. The filter may take the form of a thin foil of a suitable material such as zirconium. Thus, visible light and near ultraviolet radiation do not pass through the filter and, thus, eventually produce accurate sensitivity measurements of the resist coating the wafer. The filter is more delicate than the deflection mirror and is protected from constant damage by the deflection mirror in this regard. A third electromagnetic beam passes from filter absent visible light, debris, and unwanted ions.

A multilayer concave mirror serves as a focusing element. Such multilayer concave mirror receives the third electromagnetic beam from the filter and selects a wavelength band of EUV having a width of about 0.5 nanometers. Such multilayer mirror may be formed of molybedenum-silicon. Thus, the concave mirror serves as a focusing element to produce a fourth electromagnetic beam of EUV radiation which converges into a spot on the resist coating the wafer. The size of the focal spot can be adjusted by defocusing the multilayer concave mirror.

A shutter may also be employed in the present application to intercept the third electromagnetic beam leaving the filter. The shutter will open and close and may be programmed to produce, successively, larger periods in its open configuration, creating a series of exposure spots corresponding to increasing EUV exposure or “dose”. A process of chemical development etches away the resist in these spots to a degree corresponding to the dose received by each spot, thus, creating a series of spots with decreasing residual resist thickness. At some dose level the resist will be completely removed, leaving the underlying wafer exposed. This dose level is called the “dose-to-clear”. Consequently, the sensitivity, of the resist to EUV radiation is determined. Again, the wafer is moved manually or automatically, in coordination with the shutter openings, in an x-y direction to produce, after development, a series of etchings corresponding to the dose of EUV received, normally referred to as a “dose snake”. By observing the removal of resist from the wafer by the successive EUV spots of increasing intensity, the dose-to-clear point is determine, of course, the “dose-to-clear” event is correlated with the dose or amount of EUV passing through the filter from the source of known intensity.

In addition, the fourth electromagnetic beam emanating from the focusing element, in the form of a multilayer, concave, focusing, mirror, may pass through a wave front splitter mirror which geometrically intercepts the fourth electromagnetic beam. Such splitter mirror reflects a first portion to the resist coated wafer and passes a remaining or second portion or fraction to a witness sample. The witness sample is a multilayer mirror of the type used in typical EUV steppers. The EUV light focused on the witness sample will decompose or “cook” any organic material released by the resist from the exposure of the same. The witness sample may be tested later for reduction of reflectivity or other adverse effects which would correlate to damage or adverse effects expected in an EUV stepper. Moreover, the x-y stage may raster scan the resist such that the entire wafer is exposed to EUV radiation. Gases evolved or generated by such raster on the resist coated wafer may be detected or sniffed by a residual gas analyzer. Again, it would be necessary to detect and measure such residual gases to ascertain their effect on stepper components in a lithography apparatus. EUV reflected from the splitter mirror may be quantitatively measured by a current measuring device picoammeter linked to the surface of the splitter mirror.

It should be noted that the filter, as well as every optical component therefrom in the path to the wafer coated with a resist lies in a high vacuum of conventional configuration. The wafer and witness samples are also preferably transferred in and out of the vacuum through load locks of known configuration, without breaking the vacuum.

It may be apparent that a novel and useful resist exposure and contamination testing apparatus has been hereinabove described.

It is therefore an object of the present invention to provide a resist exposure and contamination testing apparatus which accurately determines the sensitivity of a resist to EUV in order to properly operate an EUV stepper tool in a lithography process for making chips.

Another object of the present invention is to provide a resist exposure and contamination testing apparatus which is capable of measuring the evolution of gasses from a resist during exposure to EUV

Another object of the present invention is to provide a resist exposure and contamination testing apparatus which is capable of determining the degradation of imaging objects typically used in a EUV stepper apparatus for lithography procedures.

A further object of the present invention is to provide a resist exposure and contamination testing apparatus which minimizes the downtime of lithography equipment.

A further object of the present invention is to provide a resist exposure and contamination testing apparatus which focuses an EUV beam onto a wafer coated with a resist and producing a series of exposures or a “dose snake” thereupon to determine sensitivity of the resist.

Another object of the present invention is to provide a resist exposure and contamination testing apparatus which utilizes a shutter to control exposure time of EUV on a wafer coated with a resist to obtain developed resist thicknesses verses exposure.

Yet another object of the present invention is to provide a resist and contamination testing apparatus which is capable of utilizing 300 mm or larger wafers in a testing procedure.

A further object of the present invention is to provide a resist exposure and contamination testing apparatus which continuously monitors the source of power during measurements of EUV on wafers coated with a resist by measurement of current from a component of the apparatus.

Another object of the present invention is to provide a resist exposure and contamination testing apparatus which furthers the development of EUV lithography in order to reach the 22 nm node and allows the production of chips of greater complexity.

The invention possesses other objects and advantages especially as concerns particular characteristics and features thereof which will become apparent as the specification continues.

### BRIEF DESCRIPTION OF THE SEVERAL VIEWS OF THE DRAWING

FIG. 1 is an overall schematic of the components of the apparatus of the present invention.

FIG. 2 is a top plan view of a wafer coated with a resist indicating the x-y movement thereof.

FIG. 3 is a bottom plan view of the splitter mirror of the apparatus of the present invention showing its lateral movement capability.

FIG. 4 is a top plan view of a wafer in which a “dose snake” has been obtained through successively increasing exposures of the wafer by EUV.

FIG. 5 is a sectional view taken along line 5-5 of FIG. 4.

FIG. 6 is a top plan view of a wafer in which a raster scan has been applied thereto and in which a complete exposure of the resist coating on the wafer has taken place.

FIG. 7 is a sectional view taken along line 7-7 of FIG. 6.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

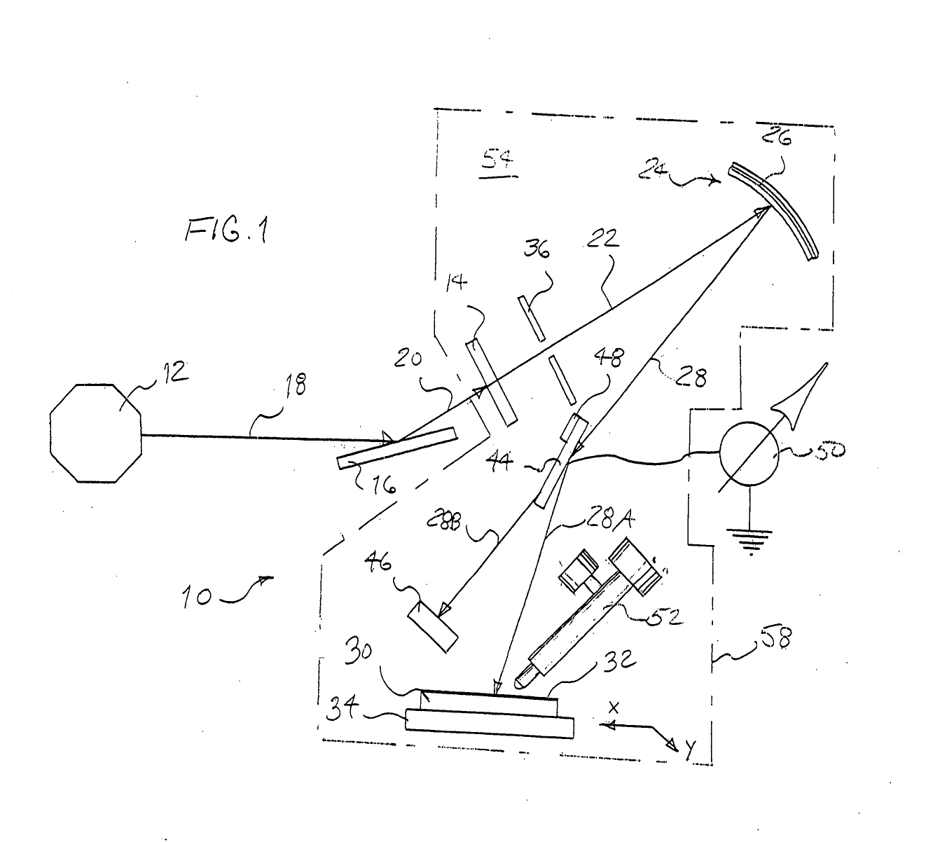

An embodiment of the invention as a whole is depicted in the drawings by reference character 10, FIG. 1. Apparatus 10 is intended for use in evaluating resists, or photoresists, that are employed in extreme ultraviolet (EUV) lithography in the manufacturing of silicon devices such as integrated circuits (IC's) or electronic chips.

Apparatus 10 includes as one of its elements a source of electromagnetic radiation 12. Such source may take the form of an electrodeless z-pinch type manufactured by Energetiq Corporation of Woburn Mass. Source 12 produces a wide range of electromagnetic radiation as well as debris in the form of particulate matter and ions. Of course other sources may be employed such as a discharge source, laser-produced plasma source, and the like. A filter 14 in the form of a very thin foil suitable material, such as zirconium, prevents visible light and near ultraviolet radiation from traveling therefrom and further through apparatus 10. Filter 14 is relatively delicate and susceptible to rapid degradation due to particles emanating from source 12 and ionic components, such as xenon ions. Should these items reach filter 14, pin holes will be formed in filter 14, causing unwanted radiation to leak through apparatus 10. Pinholes in filter 14 will also comprise the gas barrier between sources 12 and the optical chamber of apparatus 10. Also, filter 14 will normally quickly be destroyed, if left unprotected.

A deflection or sacrificial mirror 16 is employed in apparatus 10 to receive first electromagnetic beam 18 from source 12. Deflection mirror 16 may take the form of a plane polished substrate one coated with a suitable material such as ruthenium. Deflection mirror is capable of blocking particulate debris and ions, thus, preventing the same from contacting filter 14. In addition, a second electromagnetic beam 20 is reflected from deflection mirror 16 at a grazing angle of approximately 12.5 degrees. Included in second electromagnetic beam 20 is visible light, near ultraviolet radiation, and EUV radiation. Needless to say, filter 14 produces a third beam of electromagnetic radiation 22 which largely contains EUV radiation. Reflection mirror 16 is not susceptible rapid damage as is filter 14 and, thus, will be replaced infrequently. It should be noted that electromagnetic beams 18, 20, and 22 slightly diverge relative to source 12.

A focusing element 24 may take the form of a concave focusing mirror coated with the molybdenum-silicon multilayer reflecting component 26. Focusing element 24 may include forty bilayers and have radius of curvature of about 1 meter. Focusing element 24 selects a wave length band of EUV of about 0.5 nanometers wide centered on the 13.4 nanometer wave length. In essence, multilayer reflector 26 selects this particular spectral line radiation from source 12. Thus, a fourth electromagnetic beam 28 travels to a silicon wafer 30 coated with a candidate resist 32. It should be noted that fourth electromagnetic beam 28 traveling from reflector 26 is a converging beam and forms a spot of predetermined size on wafer 30 coated with resist 32. The size of such spot may be selected by the positioning of reflector 26. Typically, wafer 30 may be approximately 300 mm in diameter. In addition, wafer 30 coated with resist 32 is mounted or loaded onto a x-y stage 34 that allows translation of wafer 30 coated with resist 32, which will be explained in greater detail hereafter. X-y stage may take the form of a model no M5200 linear Stage, vacuum compatible, sold by NUTEC Components of Deer Park, N.Y. Needless to say, resist 32 on wafer 30 receives a relatively pure source of EUV radiation from focusing element 24.

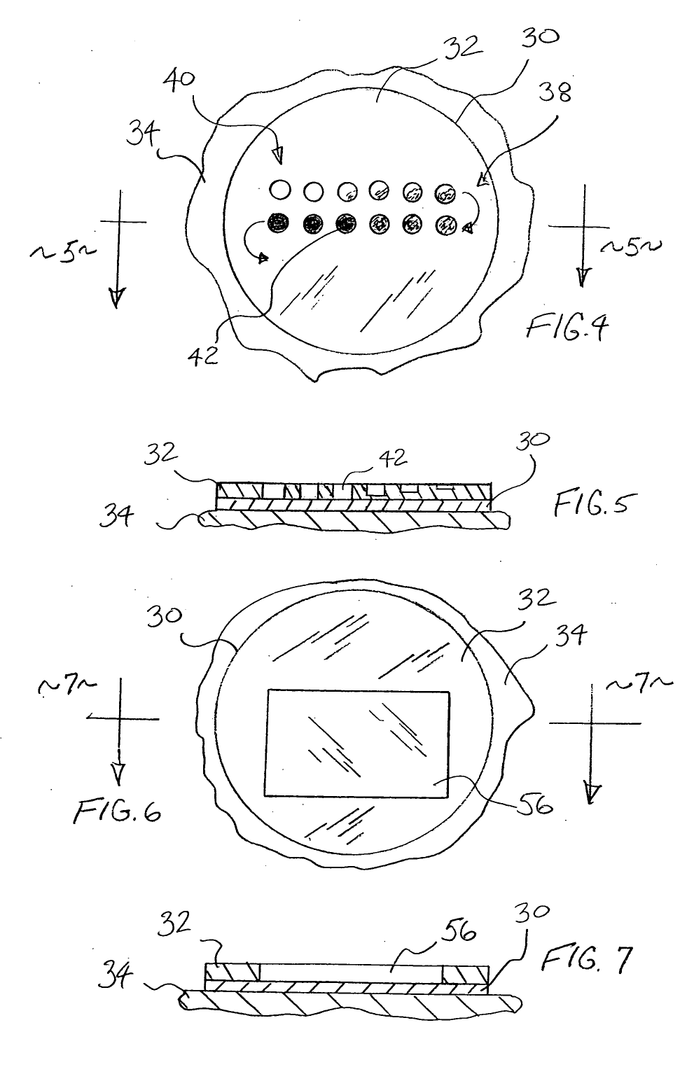

Viewing again FIG. 1, it may be observed that a shutter 36 is used to mete or control the flow of third electromagnetic beam emanating from filter 14. Shutter 36 may take the form of a model CSR3591ZMOL, 35 mm, normally open, uncased, sold by Uni-Blitz of Rochester N.Y. Shutter 36 may be regulated to create successive periods or exposures of third electromagnetic beam 22, interdicted by periods of the absence of beam 22. This results in successive impingements of fourth electromagnetic beam 28 of increasing exposure time onto resist 32 on wafer 30. Concomitant with such successive exposures of increasing duration of EUV, x-y stage 34 is moved to produce a “dose snake” 38, FIG. 4. The increased appearance and darkening of the plurality of spots of “dose snake” 38 on resist 32 in FIG. 4 indicates increased development of resist 32. Spot 42 represents an optimum amount of EUV radiation impinging on resist 32 and is referred to as the “dose-to-clear” sensitivity of resist candidate 32. It should be realized that the size of each of the plurality of spots 40 on resist 32 may be adjusted by defocusing reflector 26.

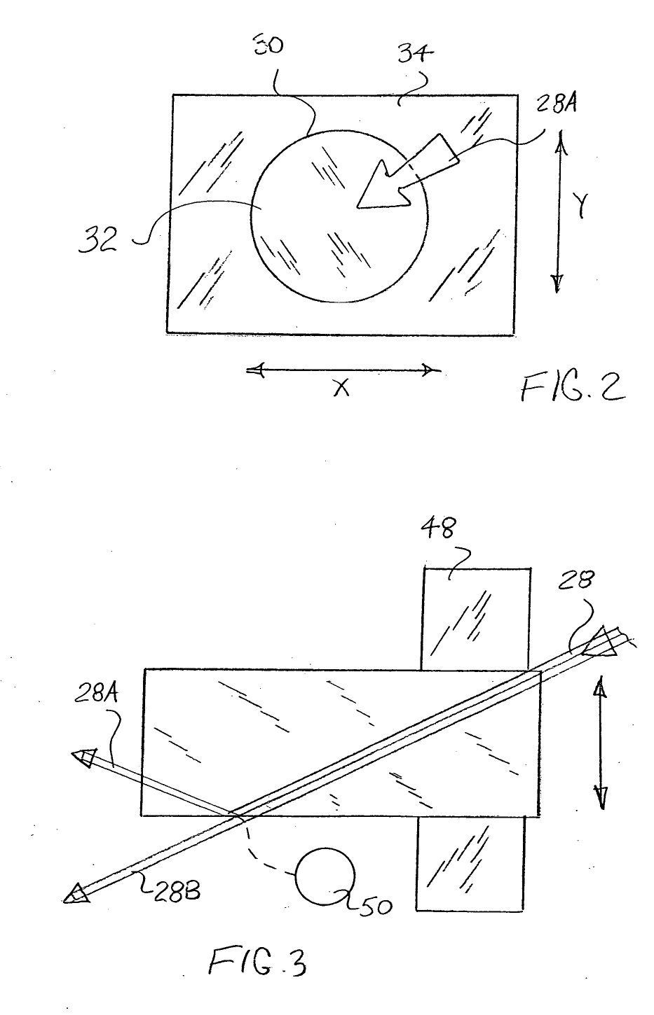

Referring again, to FIG. 1, it may be observed that a beam splitter mirror 44 is employed in apparatus 10 to geometrically select and reflect a first portion 28A of fourth electromagnetic beam 28 to resist 32 coated on wafer 30 and to pass a second portion 28B of fourth electromagnetic beam 28 to a witness sample 46. Splitter mirror may be formed of polished glass with a deposited ruthenium coating. FIGS. 1-3 represent illustrations of beam splitter mirror 44. As the exposure of witness sample 46 during the dosing of resist 32 on wafer 30 takes place, EUV light focused on witness sample 46 will decompose or “cook” any organic materials released by resist 32 during its exposure. In this regard, witness sample 46 is formed of a multilayer mirror of the type used in typical EUV stepper tool employed in EUV lithography processes. Witness sample 46 may later be tested for reduction of reflectivity or other adverse effects caused by evolved material from resist 32 during its dosing. The splitting of fourth electromagnetic beam 28 into first portion 28A and second portion 28B may be adjusted through the use of conventional lateral translator 48. Lateral translator 48 may take the form of a model 66608, 1″ Linear feed-thru, sold by MDC of Hayward, Calif. The fraction or portion 28B of fourth electromagnetic beam 28 may be varied from zero percent to one hundred percent, thereby. The absolute value of the energy flux of witness sample 46 may also be calibrated using a standard detector calibrated by NIST in the position of the witness sample (not shown). Further, an picoammeter 50 or other current measuring device electrically contacting beam split mirror 44 and will detect the photo-electron current to determine the intensity of fourth electromagnetic beam 28 during exposures of resist 32 on wafer 30. Picoammeter 50 may comprise a programmable current amplifier, model no. 428, sold by Keithley Instruments, Inc. of Cleveland Ohio.

Also, residual gas analyzer 52 may be employed to measure the composition of gases evolved from resist 32 during exposure due to impingement of EUV beam portion 28A. Residual gas analyzer 52 may take the form of a model no. PTM274215, quadrapole mass spectrometer, sold by Pfeiffer Vacuum of Nashua, N.H. Again, such information is important in the eventual use of resist 32 in stepper devices found in EUV lithography processes.

Another mode of operation may be used in apparatus 10 to produce a raster pattern on resist candidate 32 of wafer 30, FIGS. 6 and 7. X-y stage is translated in this manner to completely exposure resist 32 on wafer 30 indicated by area 56, FIGS. 6 and 7. In this mode, evolved gases from resist 32 are again measured by residual gas analyzer 52. Witness sample 46 may also be used during this mode and can be evaluated to determine any degradation of the material used to form witness sample 56 e.g. a decrease in reflectivity.

It should also be realized that at least a portion of apparatus 10 lies in a vacuum or optical chamber 54 indicated by line 58 of FIG. 1. Load locks of conventional configuration may be employed to transfer wafer 30 and witness sample 46 in and out of chamber 58 without breaking the vacuum therewithin (not shown). For example, a vacuum load lock model no. Teammate 200-LR, sold by Transfer Engineering & Manufacturing, of Fremont, Calif. may be employed for this purpose.

In operation, apparatus 10 is operated to determine the sensitivity of resist 32 on wafer 30 by using a source 12 of EUV electromagnetic radiation. First electromagnetic beam 18 from source 12 travels to defection mirror 16 which eliminates debris in the form of particulate matter and unwanted ions. A filter 14 removes visible and near ultraviolet radiation from a second electromagnetic beam 20 emanating from deflection mirror 16 and maintains a gas barrier between source 12 and the optical chamber 54 of apparatus 10. A third electromagnetic beam passing from filter 22 travels to focusing reflector 26 to create a fourth, converging, beam 28, which appears as a spot of a particular size on resist 32 of wafer 30. Ammeter 50 on a beam splitter mirror 44 determines the intensity of beam 28 while a beam splitter mirror 44 fixes the fraction of beam 28 passing to resist 32 and a witness sample 46. A residual gas analyzer 52 detects evolved gases and material emanating from resist 32 while witness sample 46 is employed to determine the effects of evolve gases thereupon, since witness sample 46 is constructed of a reflection material normally used in a EUV lithography stepper. A shutter 36 produces pulses of third electromagnetic beam 22 to focusing reflector 26 and resist candidate 32 in pre-determined amounts. Wafer 30 coated with resist candidate 32 may be moved in the x-y direction by a translator 34 in coordination with the shutter 36 pulses to produce a “dose snake” on resist 32 or a complete exposure thereof. The former mode of operation determines the “dose-to-clear” sensitivity of resist candidate 32. The latter mode of operation determines adverse effect on EUV stepper tool components. In addition, beam splitter mirror 44 may be moved laterally to determine the fraction of beam 28A hitting resist candidate 32 and beam 28B traveling to witness sample 46.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A resist exposure and contamination testing apparatus for extreme ultraviolet lithography, utilizing a wafer coated with a resist, comprising:
a. a source of electromagnetic radiation, generating a first electromagnetic beam of EUV including particulate debris and ions;
b. a deflection mirror receiving said first electromagnetic beam, said deflection mirror removing the debris from said first electromagnetic beam and reflecting a second electromagnetic beam;
c. a filter, said filter receiving said second electromagnetic beam, removing visible light therefrom, and passing a third electromagnetic beam; and
d. a focusing element, said focusing element collecting said third electromagnetic beam and emanating a fourth electromagnetic beam of extreme ultraviolet radiation onto the wafer coated with a resist.

2. The apparatus of claim 1 in which said focusing element comprises a focusing mirror emanating said fourth electromagnetic beam forming an extreme ultraviolet radiation spot on the wafer coated with a resist.

3. The apparatus of claim 1 which further comprises a shutter regulating the duration of said third electromagnetic beam traveling from said filter.

4. The apparatus of claim 3 in which said shutter produces successive doses of said third electromagnetic beam of successive time duration.

5. The apparatus of claim 4 in which said focusing element comprises a focusing mirror emanating said fourth electromagnetic beam forming an extreme ultraviolet radiation spot on the wafer coated with a resist.

6. The apparatus of claim 3 which further comprises a moveable support for the wafer coated with a resist.

7. The apparatus of claim 6 in which said focusing element comprises a focusing mirror emanating said fourth electromagnetic beam forming an extreme ultraviolet radiation spot on the wafer coated with a resist.

8. The apparatus of claim 7 in which said shutter produces successive bursts of said third electromagnetic beam of successive time duration.

9. The apparatus of claim 1 which further comprises a beam splitter mirror and a witness sample, said beam splitter mirror receiving said fourth electromagnetic beam from said focusing element and reflecting a first portion thereof to the wafer coated with a resist and passing a second portion to said witness sample.

10. The apparatus of claim 9 in which said focusing element comprises a focusing mirror emanating said fourth electromagnetic beam forming an extreme ultraviolet radiation spot on the wafer coated with a resist.

11. The apparatus of claim 10 which further comprises a shutter regulating the duration of said third electromagnetic beam traveling from said filter.

12. The apparatus of claim 11 which further comprises a moveable support for the wafer coated with a resist.

13. The apparatus of claim 9 which further comprises a movable support for said beam splitter mirror.

14. The apparatus of claim 13 in which said focusing element comprises a focusing mirror emanating said fourth electromagnetic beam forming an extreme ultraviolet radiation spot on the wafer coated with a resist.

15. The apparatus of claim 14 which further comprises a shutter regulating the duration of said third electromagnetic beam traveling from said filter.

16. The apparatus of claim 9 which further comprises a vacuum chamber enclosing said filter, focusing element, beam splitter mirror, and said witness sampler.

17. The apparatus of claim 16 which further comprises a residual gas analyzer for detecting evolved gases at said wafer coated with a resist within said vacuum chamber.

18. The apparatus of claim 9 which further comprises a detector gaging the quantity of said first portion of said fourth electromagnetic beam impinging on the wafer coated with a resist.

19. The apparatus of claim 18 in which said detector comprises an ammeter.

20. The apparatus of claim 18 in which said focusing element comprises a focusing mirror emanating said fourth electromagnetic beam forming an extreme ultraviolet radiation spot on the wafer coated with a resist.

21. The apparatus of claim 20 which further comprises a shutter regulating the duration of said third electromagnetic beam traveling from said filter.

22. The apparatus of claim 21 which further comprises a moveable support for the wafer coated with a resist.

23. The apparatus of claim 1 which further comprises a residual gas analyzer for detecting evolved gases at said wafer coated with a resist.
